(19) United States
(12) Patent Application Publication
(10) Pub. No.: US 2011/0014526 A1
(43) Pub. Date: Jan. 20, 2011

(54) High temperature direct coal fuel cell

(76) Inventor: Turgut M. Gür, Palo Alto, CA (US)

Correspondence Address: LUMEN PATENT FIRM, 350 Cambridge Avenue, Suite 100, PALO ALTO, CA, 94306, US

(21) Appl. No.: 12/924,073

(22) Filed: Sep. 20, 2010

Related U.S. Application Data
(63) Continuation-in-part of application No. 11/372,553, filed on Mar. 9, 2006, now Pat. No. 7,799,472.
(60) Provisional application No. 60/681,920, filed on May 16, 2005.

(51) Int. Cl. H01M 8/22

(52) U.S. Cl. 429/405; 429/403

(57) ABSTRACT

A fuel cell is provided that includes a chemically non-reactive and non-consumable molten anode that is chemically stable in composition and structure and is catalytically active, a cathode, where one surface of the cathode is in contact with air, where the air supplies oxygen to the cathode, a solid oxide electrolyte that selectively transports oxide ions from the cathode to the anode for an oxidation reaction, where the solid oxide electrolyte is disposed between the anode and the solid cathode, and a single temperature zone, where the anode is in direct physical contact with a carbon-containing fuel and electrical current is generated by the oxidation of the carbon-containing fuel by the oxygen.

### CROSS-REFERENCE TO RELATED APPLICATIONS

This application is a Continuation in Part of and claims priority to application Ser. No. 11/372,553, filed Mar. 9, 2006, which claims priority to provisional application No. 60/681,920 filed on May 16, 2005 which are hereby incorporated by reference.

### FIELD OF THE INVENTION

This invention relates to the field of fuel cells, and in particular to the field of high temperature fuel cells for the direct electrochemical conversion of carbon to electrical energy. This invention is further directed to molten anodes in high temperature fuel cells.

### BACKGROUND OF THE INVENTION

Coal is a primary energy source with a high volumetric energy density of 27,000 MJ/m³ that offers a great advantage over natural gas (32 MJ/m³), biomass (1950 MJ/m³) and gaseous hydrogen (10.9 MJ/m³). Only liquefied fuels, such as gasoline (31,000 MJ/m³), liquid propane (25,000 MJ/m³) and methanol (18,000 MJ/m³) offer such high volumetric energy densities, however they are merely energy carriers (as opposed to being primary energy sources, where they are produced from primary sources by expensive and inefficient processes.

Further, coal is the most abundant and inexpensive primary energy source with sufficient reserves to meet the world's energy requirement for many decades, even centuries to come. For example, it is projected that proven coal reserves in the USA should last for more than 250 years.

Use of heat engines to convert the chemical energy of coal to useful work requires multiple processing steps that suffer from Carnot constraints that ultimately lower conversion efficiencies. Typically, coal fired power plants operate with efficiencies of 33-35%. Direct electrochemical conversion of coal to electrical energy is a single step process and is not subject to Carnot constraint, which offers the possibility of achieving substantially higher efficiencies. For example, the theoretical value of the electrochemical conversion efficiency for the oxidation of carbon to carbon dioxide remains at about 100% even at elevated temperatures due to zero entropy change of the reaction. It is expected that practical conversion efficiencies of about 70% can be obtained for direct carbon conversion.

The earliest attempt to directly consume coal in a fuel cell used a carbon rod as the anode and platinum as the oxygen electrode in a fuel cell that employed molten potassium nitrate as the electrolyte. When oxygen was blown on to the Pt electrode a current was observed in the external circuit. However, the results were not encouraging because of the direct chemical oxidation of carbon by the potassium nitrate electrolyte.

A later attempt to generate electricity directly from coal used a molten sodium hydroxide electrolyte contained in an iron pot, which served as the air cathode, and a carbon rod as a consumable anode. The cell was operated at about 500° C. and current densities of over 100 mA/cm² were obtained at about 1 volt. A 1.5 kW battery was constructed that include over 100 of these cells, which operated intermittently for over six months. Unfortunately, this attempt did not give reliable information about cell characteristics and life of his battery. It was later suggested that the electrochemical reaction at the anode was not from the oxidation of carbon but from hydrogen that was produced, along with sodium carbonate, by the reaction of carbon with molten sodium hydroxide. Owing to this undesirable side reaction involving the electrolyte and rendering it unstable in that environment, the molten alkali electrolytes were abandoned and replaced by molten salts such as carbonates, silicates and borates.

It was later suggested that the condition for a chemically stable electrolyte is only met by the use of an ionically conducting solid electrolyte. For this purpose, a battery having eight yttria stabilized zirconia electrolyte crucibles immersed in a common magnetite (i.e., Fe₃O₄) bath was built. The anode compartment was filled with coke and the cell was operated at about 1050° C. The open circuit battery potential was 0.83 volts, about 0.2 volts lower than that measured with single cells. At a cell voltage of about 0.65 volts the current density was about 0.3 mA/cm², too low for practical use. Furthermore, at these high operating temperatures, it is thermodynamically possible to carry out only partial oxidation of carbon, which would hence reduce the efficiency of the fuel cell significantly.

High temperature fuel cells employing either molten carbonate or solid oxide ceramic electrolytes have been reported. In these cells, coal derived fuels were employed as consumable gaseous fuels. Presently, the high temperature solid oxide fuel cells under development in various laboratories around the world use either H₂ derived from natural gas by internal reforming in the cell, or H₂/CO mixtures derived from coal by an a priori gasification process.

A molten hydroxide fuel cell operating at 400-500° C. has been proposed that includes a carbon anode surrounded by a molten hydroxide electrolyte. In this attempt, air is forced over the metallic cathode where the reduction of oxygen generates hydroxide ions. The hydroxide ions are transported through the molten NaOH electrolyte to the anode where they react with the carbon anode releasing H₂O, CO₂. These electrons travel through the external circuit to the cathode, and generate electricity.

A carbon anode in a molten carbonate electrolyte system for direct conversion of carbon to electricity has been developed, which employs a molten carbonate electrolyte that holds nanosize carbon particles dispersed in it. The anode and cathode compartments are separated by a porous yttria stabilized zirconia (YSZ) matrix, which serves to hold the molten electrolyte and allows transport of carbonate ions from the anode side to the cathode compartment. Suitable metals such as Ni are employed for anode and cathode materials. At the anode, dispersed carbon particles react with the carbonate ion to form CO₂ and electrons, while oxygen from air react with CO₂ at the cathode to generate carbonate ions. As the carbonate ions formed at the cathode migrate through the molten electrolyte towards the anode, the electrons liberated at the anode travel through the external circuit towards the cathode generating electricity.

A fuel cell employing a molten Fe anode and a yttria stabilized zirconia (YSZ) solid electrolyte immersed in the molten anode has been further proposed. The operating temperature of the cell needs to be considerably higher than the melting point of Fe, which is 1535° C. Indeed, their modeling was necessarily done for extremely high temperatures up to 2227° C. (or 2500 K). It was assumed that finely divided carbon particles are dispersed in the molten Fe anode. It was suggested to coat the cathode side of the YSZ electrolyte with a porous layer of Pt where the oxygen from the air would undergo a reduction reaction. The resulting oxide ions would be transported through the YSZ solid electrolyte towards the anode where they would emerge into the molten Fe bath and electrochemically react with the Fe to form iron oxide, which is then reduced by chemical reaction with the dispersed carbon particles. The electrons released during this anodic reaction would travel in the external circuit generating electricity.

A similar approach has been pursued with a fuel cell that uses a carbon-based anode. The electrolyte was chosen from materials with melting temperatures from 300° C. to 2000° C. This included molten electrolytes (such as molten carbonate) as well as solid oxide electrolytes (such as yttria stabilized zirconia). The latter allowed transport of oxygen ions generated from air at the cathode. Particularly, molten Sn was used as the anode and the cell operated in a two-step process. During the first phase, the oxygen transported through the electrolyte oxidizes the molten Sn anode to SnO. In the second step, carbon fuel delivered into the anode compartment reduces the SnO back to metallic Sn, and the cycle is repeated.

In addition, molten metal anodes employed in prior art all form oxide layers (e.g., SnO, SnO₂, FeO, Fe₂O₃, etc) at the anode surface that block the transport of oxide ions emerging from the solid electrolyte. They also impede electrons since these oxides are poor electronic conductors. In either case, the oxide layer formation at the anode is an impediment to oxide ion transport as well as the anodic charge transfer reaction.

The above-described art uses the carbon fuel merely for the purpose of chemically reducing the resulting oxide barrier layer formed at the anode back to its metallic state in a two step process in order to operate their fuel cell.

The prior art employs electronically nonconducting molten salt electrolytes for transporting oxide ions in the form of either OH⁻ (hydroxide ions) or CO₃^{═} (carbonate ions).

Predominantly oxide-ion conducting solids are known. Among these solids, zirconia-based electrolytes have widely been employed as electrolyte material for solid oxide fuel cells (SOFC).

Zirconium dioxide has three well-defined polymorphs, with monoclinic, tetragonal and cubic structures. The monoclinic phase is stable up to about 1100° C. and then transforms to the tetragonal phase. The cubic phase is stable above 2200° C. with a CaF₂ structure. The tetragonal-to-monoclinic phase transition is accompanied by a large molar volume (about 4%), which makes the practical use of pure zirconia impossible for high temperature refractory applications. However, addition of 8-15 m % of alkali or rare earth oxides (e.g., CaO, Y₂O₃, Sc₂O₃) stabilizes the high temperature cubic fluorite phase to room temperature and eliminates the undesirable tetragonal-to monoclinic phase transition at around 1100° C. The dopant cations substitute for the zirconium sites in the structure. When divalent or trivalent dopants replace the tetravalent zirconium, a large concentration of oxygen vacancies is generated to preserve the charge neutrality of the crystal. It is these oxygen vacancies that are responsible for the high ionic conductivity exhibited by these solid solutions. These materials also exhibit high activation energy for conduction that necessitates elevated temperatures in order to provide sufficient ionic transport rates. The electronic contribution to the total conductivity is several orders of magnitude lower than the ionic component at these temperatures. Hence, these materials can be employed as solid electrolytes in high temperature electrochemical cells.

The usefulness of solid oxide electrolytes is based on two important features. First, the chemical potential difference of oxygen across the electrolyte is a measure of the open circuit potential via the Nernst Equation,

E=−(RT/nF)ln(PO₂′/PO₂″) (1),

where E is the equilibrium potential of the cell under open circuit conditions, R is the gas constant, F is Faraday's constant, n is the number of electrons per mole (in the case of O₂, n=4), and PO₂ denotes the partial pressure of oxygen. Hence the electrolyte can serve as a static oxygen sensor. Secondly, the electrical charge passed through the electrolyte is carried directly by oxide ions. Hence, stabilized zirconia can be used as an electrochemical transducer involving oxygen transport.

What is needed is a direct coal fuel cell (DCFC) with a solid oxide electrolyte that facilitates oxide ion transport and supplies the oxygen for the oxidation of carbon and other reactants (such as hydrogen, sulfur etc) at the anode.

What is further needed is a DCFC that uses a solid, dense, and nonporous solid oxide ceramic electrolyte that selectively transports oxide ions in the form of O^{═} only, so their ionic conduction mode and media are vastly different.

What is further needed is a DCFC that uses an electronically conducting molten anode that is stable in oxygen environment and does not form oxides at the operating temperature of the cell that precludes and excludes the formation of an oxide ion blocking barrier layer.

What is further needed is a DCFC that employs the carbon fuel for the sole purpose of oxidizing.

What is needed is a DCFC that uses a non-consumable and non-reactive molten anode to generate electricity from carbon.

### SUMMARY OF THE INVENTION

A fuel cell is provided that includes an anode that is chemically non-reactive and non-consumable, chemically stable in composition and structure and is catalytically active, a cathode, where one surface of the cathode is in contact with air, where the air supplies oxygen to the cathode, a solid oxide electrolyte that selectively transports oxide ions from the cathode to the anode for an oxidation reaction, where the solid oxide electrolyte is disposed between the anode and the solid cathode, and a single temperature zone, where the anode is in direct physical contact with a carbon-containing fuel and electrical current is generated by the oxidation of the carbon-containing fuel by the oxygen.

In one aspect of the invention, the anode is an electronically-conducting molten anode. Here, the electronically-conducting molten anode is silver.

In another aspect of the invention, the carbon containing fuel further includes a sequestering agent that is suitable for CO₂/SO₂ capture.

In a further aspect of invention, the solid oxide electrolyte includes a solid oxide electrolyte tube, where the solid oxide electrolyte tube is disposed between the anode and the cathode. Here, the cathode includes a cathode tube, where the oxygen containing air flows there through. Further, the anode includes a molten anode that is disposed in the solid oxide electrolyte tube, where the solid oxide electrolyte tube is surrounded by the oxygen containing air.

In yet another aspect of the invention, anode is a molten anode that includes a molten metal bath, where the metal does not form a stable oxide under conditions of operation.

In yet another aspect of the invention, the anode is a molten anode that includes a molten metal bath, where the metal has a sufficiently high solubility and diffusivity for oxygen under conditions of operation.

According to another aspect of the invention, oxidation of the carbon-containing fuel is by lattice oxygen provided through the solid oxide electrolyte to the anode.

In one aspect of the invention, the carbon-containing fuel includes a carbon rich substance.

In another aspect of the invention, the fuel cell is a generally shell-and-tube configuration, where a bed of the carbon-containing fuel and the anode is outside of the tube.

In a further aspect of the invention, the fuel cell is a generally shell-and-tube configuration, where a bed of the carbon-containing fuel and the anode is inside of the tube.

In yet another aspect of the invention, the fuel cell has an operating temperature in the range 250 to 1300 degrees Centigrade.

According to one aspect of the invention, the carbon-containing fuel can include coal, charcoal, peat, coke, char, petroleum coke, oil sand, tar sand, waste plastics, biomass, agriculture waste, forest waste, municipal waste, human waste, biological waste, or carbon produced by pyrolysis of a carbonaceous substance of solid, liquid or gaseous form.

In one aspect of the invention, the solid oxide electrolyte is a solid oxide electrolyte layer coated onto the cathode, where the cathode is porous, where the solid oxide electrolyte layer has a thickness in a range of 1 to 100 microns.

In another aspect of the invention, the solid oxide electrolyte can be an oxide that includes Hf, Zr, Y, Sc, Yb, La, Ga, Gd, Bi, Ce, Th, where the oxides are doped with oxides such as zirconium oxide doped with yttrium oxide, alkaline earth metals and rare earth metals.

### BRIEF DESCRIPTION OF THE DRAWINGS

FIG. 1 shows the theoretical conversion efficiency and the expected open circuit voltage as a function of temperature for the electrochemical oxidation reaction of carbon, according to one embodiment of the invention.

FIG. 2 Shows a schematic drawing and operating principle of the direct carbon fuel cell showing the details of the cell cross section (not to scale), ionic transport, and electrode reactions. Right: The thin film solid oxide electrolyte (white annulus) is sandwiched between the porous cathode support tube indicated by the inner gray shade, and the outer porous anode layer. Left: solid electrolyte and the cathode allows transport of oxide ion only, which oxidize carbon at the anode and release its electrons to the external circuit generating electricity. In a preferred embodiment, the direct carbon fuel cell may be operated at a single temperature, such that the reaction is in a single temperature zone.

FIG. 3 shows a schematic stalactite design of the agitated bed direct coal fuel cell illustrates the general design features including one-end closed ceramic tubular cell and the capability to capture any entrained coal particles in a cyclone, and recycling the captured coal particles and part of the CO₂ back to the coal bed, the latter in order to enhance mass transport by agitation.

FIG. 4 shows a schematic stalactite design of the agitated bed direct coal fuel cell illustrates the general design features including one-end closed ceramic tubular cell and recycling part of the CO₂ back to the coal bed in order to enhance mass transport by agitation.

FIG. 5 shows a schematic stalactite design of the immersion bed direct coal fuel cell illustrates the general design features including one-end closed ceramic tubular cell. There is no recycling of the CO₂ back to the coal bed for agitation.

FIG. 6 shows a schematic stalagmite design of the immersion bed direct coal fuel cell illustrates the general design features including one-end closed ceramic tubular cell. There is no recycling of the CO₂ back to the coal bed for agitation.

FIG. 7 shows a shell-and-tube type design where the pulverized coal bed is outside the tube in touch with the anode surface. This particular schematic does not illustrate CO₂ or captured coal rcycling, but these features can easily be incorporated and falls within the scope of this invention.

FIG. 8 shows a shell-and-tube type design (inverted version of FIG. 7) where the pulverized coal bed is now inside the tube in touch with the anode surface that is also inside the tube. The annulus between the metal shell and the cathode surface facing the metal shell allows a flow of air. This particular schematic does not illustrate CO₂ or captured coal recycling, but these features can easily be incorporated and falls within the scope of this invention.

FIG. 9 shows a schematic of the two-chamber flat plate fluidized bed fuel cell design where the pulverized coal bed is in touch with the anode surfaces of the ceramic membrane assemblies. More chambers are possible. This particular schematic also applies to corrugated plate design of ceramic membrane assemblies. It does not illustrate CO₂ or captured coal recycling, but these features can easily be incorporated and falls within the scope of this invention.

FIG. 10 shows a schematic drawing of a direct coal conversion fuel cell featuring a molten metal anode charged with carbon fuel and CO₂/SO₂ sequestering agent, according to one embodiment of the invention.

FIG. 11 shows a schematic drawing of a shell-and-tube type direct coal conversion fuel cell with cathodes on internal surfaces of tubes, and featuring a molten metal anode charged with carbon fuel and CO₂/SO₂ sequestering agent, according to one embodiment of the invention.

FIG. 12 shows a schematic drawing of a shell-and-tube type direct coal conversion fuel cell with cathodes on outside surfaces of tubes, and featuring a molten metal anode charged with carbon fuel and CO₂/SO₂ sequestering agent, according to one embodiment of the invention.

### DETAILED DESCRIPTION OF THE INVENTION

The invention is directed to a fuel cell for the direct conversion of a carbon-containing fuel into electricity. The fuel cell comprises a molten anode, a solid cathode, and an electrolyte. In a preferred embodiment, there is a thin film solid oxide electrolyte, which is sandwiched between a porous cathode and an outer porous anode layer. In a preferred embodiment, the fuel cell operates at elevated temperature, with a single temperature zone. In another preferred embodiment, the fuel cell utilizes direct physical contact of an anode surface with carbon-containing particles.

The electrochemical conversion of coal into electricity involves a high temperature fuel cell that features an oxide ion selective solid electrolyte that supplies the oxygen required for the electrochemical oxidation of carbon. Solid carbonaceous fuel is introduced into the anode compartment of the cell with or without other solid constituents, such as sequestering agents for capturing the CO₂ and SO₂ produced.

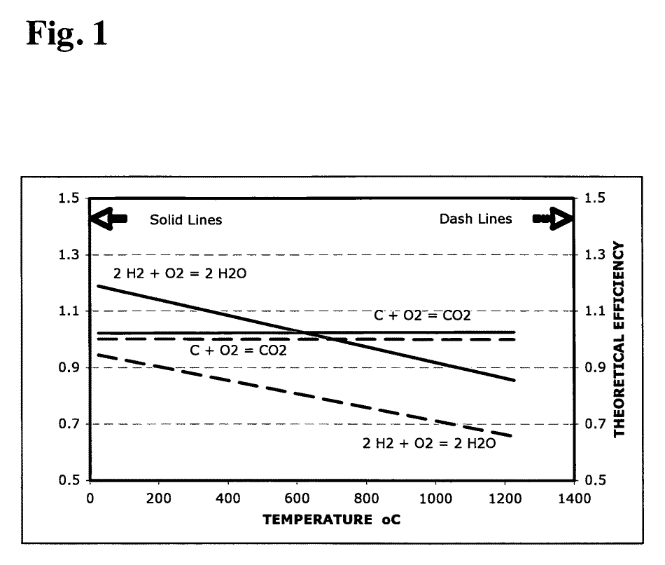

The open circuit voltage of the fuel cell is determined by the carbon-oxygen equilibrium at the anode, since the oxygen activity on the cathode side is fixed by air. FIG. 1 shows the theoretical conversion efficiency and the expected open circuit voltage as a function of temperature for the electrochemical oxidation reaction of carbon. Note the temperature independence of E and efficiency for the carbon oxidation reaction, while the behavior is strongly dependent on temperature for the case of hydrogen. FIG. 1 also compares the carbon-oxygen couple with a couple for hydrogen, which shows strong temperature dependence, where a solid oxide fuel cell (SOFC) using hydrogen as fuel and operating at high temperatures will have significantly lower open circuit voltage as well as theoretical efficiency than one that employs carbon as fuel. This is primarily because the entropy change during carbon oxidation is negligibly small, and the Gibbs free energy for carbon oxidation is nearly independent of temperature. The situation is different for the oxidation of hydrogen, which exhibits strongly negative temperature dependence and needs to be produced from other resources first, while carbon is an abundant and cheap source of energy that is readily available. FIG. 1 indicates 100% theoretical efficiency and slightly over 1-volt open circuit voltage, both of which are practically independent of temperature over the entire useful range.

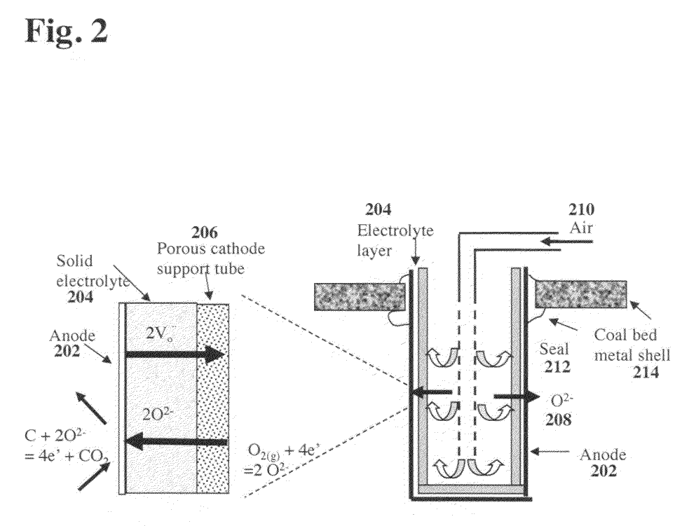

A typical schematic of the fuel cell ceramic tube involves a thick porous ceramic cathode that provides mechanical integrity for the multilayer structure. Another typical schematic of the fuel cell involves flat or corrugated plates of multilayered ceramic membrane assemblies. Other cell geometries, including flat tubes, rectangular or square tubes, and planar configurations, etc. are also possible and is covered under this invention. A thin, impervious layer of yttria stabilized zirconia (YSZ) solid electrolyte is coated on the outer surface of the cathode tube. Another thin but preferably porous layer that serves as the anode is then deposited on top of the YSZ as the outermost layer. A schematic of the tube structure and its operating principle is shown in FIG. 2. Typically, the YSZ and porous anode layers are each 10-50 μm thick, while the cathode support tube may be about 1-2 mm in wall thickness. The porous cathode support tube is made of a mixed conducting perovskite while the porous anode layer is typically made of catalytically active cermet or a mixed conducting oxide.

FIG. 2 shows an anode 202, a solid oxide electrolyte 204, a cathode 206, oxygen ions 208, air 210, a seal 212, and a metal shell 214.

YSZ is the preferred solid electrolyte 204 for its high stability and ionic conductivity. However, scandia stabilized zirconia (SSZ) has an even higher conductivity than its yttria counterpart.

Also, it is possible to employ tetragonal zirconia, which is known to possess higher conductivity and better thermal shock resistance than cubic zirconia electrolytes. Similarly, other oxide ion conductors such as doped cerates (e.g. Gd₂O₃.CeO₂) and doped gallates (e.g., La₂O₃.Ga₂O₂) can also be considered for the thin electrolyte 204 membrane.

The inner surface of the cathode 206 support tube is in contact with air 210 to furnish the oxygen 208 needed for the oxidation reaction at the anode 202, while the outer surface of the anode 202 is in direct, physical contact with the carbon fuel. The YSZ solid oxide electrolyte 204 film in between serves as a selective membrane for transporting oxygen 208 ions from the air 210, leaving behind the nitrogen. The oxygen 208 picks up electrons from the external circuit through the cathode 206 and is reduced to oxide ions, which are then incorporated into the YSZ solid electrolyte 204.

Using Kroger-Vink defect notation, the electrochemical reduction of oxygen 208 at the cathode 206 takes place as follows:

O_{2(g)}+2Vₒ″_{(YSZ)}+4e′_{(electrode)}=2Oₒ^{x}_{(YSZ)} (2)

While the oxygen vacancies, Vₒ″_{(YSZ)}, migrate under the influence of the chemical potential gradient through the YSZ solid electrolyte 204 film from the anode 202 to the cathode 206, oxygen 208 ions are transported in the reverse direction from the cathode 206 to the anode 202 where they participate in the electrochemical oxidation of carbon.

C+2Oₒ^{x}_{(YSZ)}=CO_{2(g)}+2Vₒ″_{(YSZ)}+4e′_{(electrode)} (3)

The electrons released during the oxidation reaction at the anode 202 travel through the external circuit towards the cathode 206, producing useful electricity. The oxygen 208 chemical potential difference between the anode 202 and the cathode 206 (i.e., air 210) provides nearly 1 volt of open circuit voltage.

For obtaining maximum conversion efficiency, it is important that the oxidation reaction of carbon primarily takes place at the anode 202 surface by lattice oxygen (i.e., Eq. (3)). The presence of lattice oxygen is preferred in embodiments involving the single temperature reaction zone and the direct physical contact of the anode 202 surface with the particles of carbon-containing fuel.

Expressed this time in ionic notation, the desired reaction is

C₍ₛ₎2O²⁻_{(YSZ)}=CO_{2(g)}+4e′_{(electrode)} (4)

So many of the gas phase reactions should be minimized. These include the reactions at the solid carbon-gas interface,

C₍ₛ₎+½O_{2(g)}=CO_{(g)} (5)

C₍ₛ₎+O_{2(g)}=CO_{2(g)} (6)

as well as the gas phase oxidation of CO by molecular oxygen 208 supplied from the cathode 206 through the YSZ electrolyte 204.

CO_{(g)}+½O_{2(g)}=CO_{2(g)} (7)

and the reverse Bouduard reaction that leads to carbon precipitation

2CO_{(g)}=C₍ₛ₎+CO_{2(g)} (8)

In short, the desired reaction is (4) for obtaining maximum conversion efficiency. Therefore it is important to bring coal particles in direct physical contact with the active anode 202 surface. This can only be achieved if the anode 202 surfaces and the coal particles reside in immediate physical proximity such that they experience the same temperature regime, and not thermally and spatially separated from one another. Hence, a single temperature zone fuel cell reactor design is the preferred embodiment in this invention where the active surfaces of the anode 202 and the coal particles experience direct physical contact and the same temperature space.

This is achieved by immersing the solid electrolyte 204 containing cell tubes inside the pulverized coal bed, where the coal bed and the tubes reside in the same thermal zone. The coal particles touching the anode 202 surface are readily oxidized by the oxygen 208 provided at the anode 202 surface through the solid electrolyte 204 membrane. Since the electrolyte 204 membrane is selective only to oxygen 208, the nitrogen component of air 210 stays behind in the cathode 206 compartment. This way, there is no N₂ or oxides of nitrogen (NOₓ) produced in the coal bed other than whatever nitrogen was present in the coal feed originally. The absence of N₂ and NOₓ in the flue gas stream is of course a major advantage of this invention in many important ways. It eliminates emissions of toxic NOₓ into the environment, and where regulated, it also eliminates very expensive separation and purification processes for removing NOₓ from the flue gases before they are discharged into the atmosphere. Furthermore, it eliminates the latent heat lost to N₂ during the combustion process, as is the case in conventional coal-fired power generation technologies. Finally, this invention makes it easy and inexpensive to capture and sequester the CO₂ since the flue gases from the direct coal fuel cell is primarily CO₂. This point is important for compliance with Kyoto protocols regarding greenhouse gas emissions.

The carbon-fuel comprises any carbon rich substance including: all grades and varieties of coal, charcoal, peat, coke, char, petroleum coke, oil sand, tar sand, waste plastics, biomass, agriculture waste, forest waste, municipal waste, human waste, biological waste, or carbon produced by pyrolysis of a carbonaceous substance of solid, liquid or gaseous form. For brevity, the carbon-fuel substances listed above may be referred to as “coal” in this document.

Several different design alternatives are provided as examples to achieve direct, physical contact of the anode 202 surface with the coal particles. Other design alternatives are also possible. These designs may or may not involve recycling or circulation of an inert gas, such as He, Ar, N₂ or CO₂, to agitate the coal bed to enhance mass transport of reaction products away from the anode 202 surface so as not to block, hinder, or slow down the next unit of oxidation reaction taking place.

The coal bed operates in the temperature range 500 to 1300° C. This range provides the spectrum for the optimum operation of the coal bed and the oxidation process. Thermodynamically, conversion of carbon to carbon dioxide has an inverse temperature dependence and hence is favored more with decreasing temperatures. More specifically, the formation of CO₂ is thermodynamically favored at temperatures below about 720° C., while the partial oxidation product CO is stable above this temperature. In other words, the thermodynamic cross over between full oxidation and partial oxidation of carbon occurs around 720° C. Naturally, thermodynamics dictate only the natural tendency of a system to change or react, but does not govern how fast the system undergoes change. Kinetics and diffusion dictate collectively how fast a reaction or change will occur, and this is an exponential function of temperature. So higher temperatures offer faster reaction rates.

Accordingly, the kinetics and product distribution of the carbon conversion reaction is best optimized when the operating temperature range of the coal bed lies between 500 and 1300° C.

There is another consideration that affects the operating temperature of the system. That has to do with the transport of oxide ions through the ceramic electrolyte 204 membrane, which is a highly thermally activated process as discussed earlier, and prefers high operating temperatures. The oxide ions transported across the membrane oxidize the carbon at the anode 202 compartment to generate electricity. In order to produce practically significant and useful levels of electrical current, which is intimately associated with the transport rate of oxide ions through the membrane via the well-known Faraday's equation, the coal bed may operate between 600 and 1100° C., where the ionic conductivity of the electrolyte 204 membrane is larger than 10⁻⁴ S/cm. To obtain even better performance, the coal bed may optionally operate in a temperature range of 700 to 1000° C.

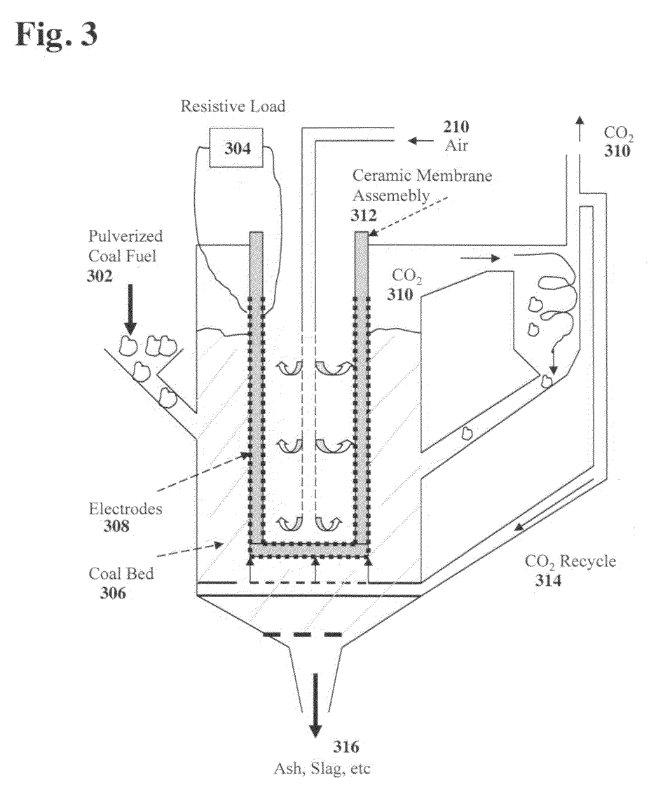

FIG. 3 shows coal fuel 302, a resistive load 304, a coal bed 306, electrodes 308, CO₂ 310, a membrane assembly 312, recycled CO₂ 314, and ash and slag 316.

The schematic of the agitated bed direct coal fuel cell shown in FIG. 3 shows the general design features including the stalactite design of one-end closed ceramic tubular cell. The agitated bed is preferably made of a stainless steel shell with proper ports for feeding the pulverized coal into the bed, and discharging the flue gases. It also has the capability to capture any entrained coal particles in a cyclone, and recycling both the captured coal particles and part of the CO₂ gas 314 back to the coal bed 306, the latter in order to enhance mass transport by agitation of the coal bed 306 by gas flow.

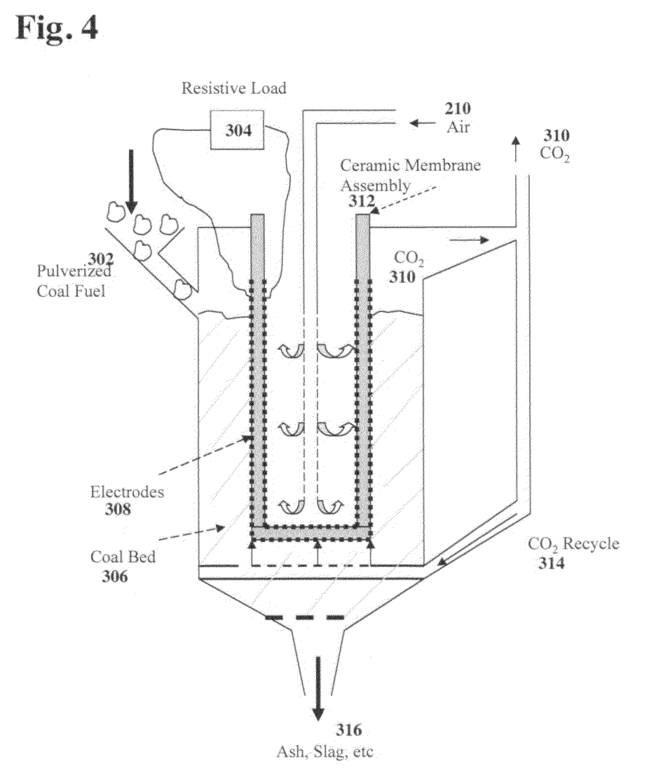

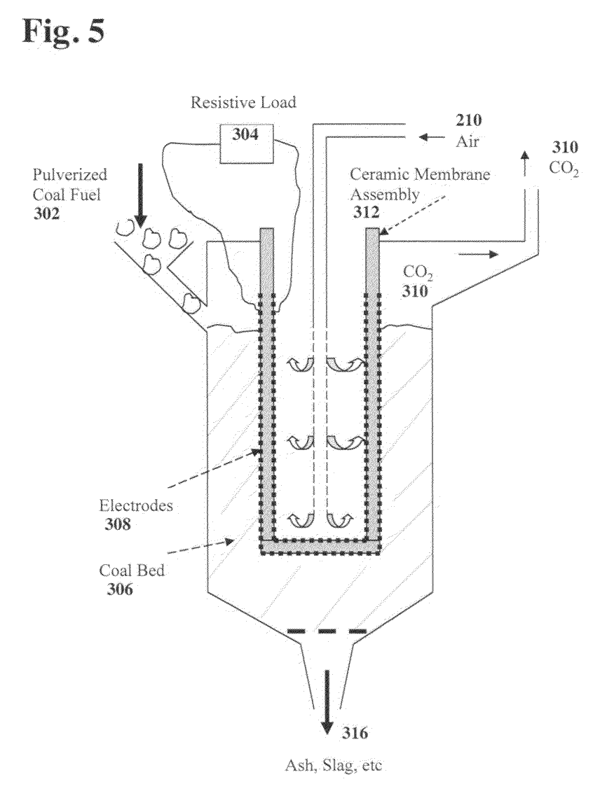

Variant modes of the stalactite design are shown in FIGS. 4 and 5 as examples, where the former shows only CO₂ recycling 314 for agitation of the coal bed 306.

Another design concept shown in FIG. 5 is an immersion bed direct coal fuel cell where the coal bed 306 is immobile and there is no forced agitation of the bed caused by the recycling of the CO₂ product gas.

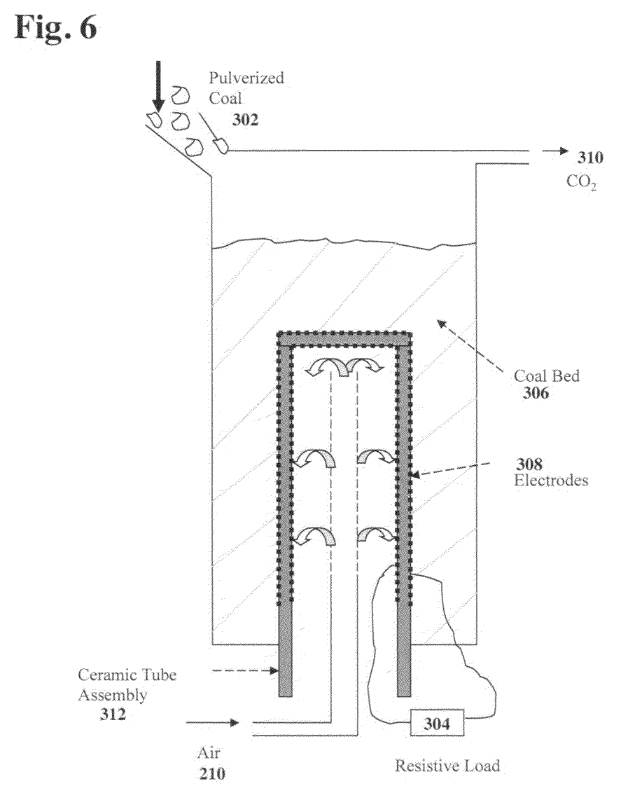

Yet another design concept is the stalagmite configuration of the ceramic tube cells as shown in FIG. 6, which also shows an immersion type of coal bed 306 operation without CO₂ recycling 314. Naturally, the stalagmite design concept is also possible for the other modes of operation described above, as well as others.

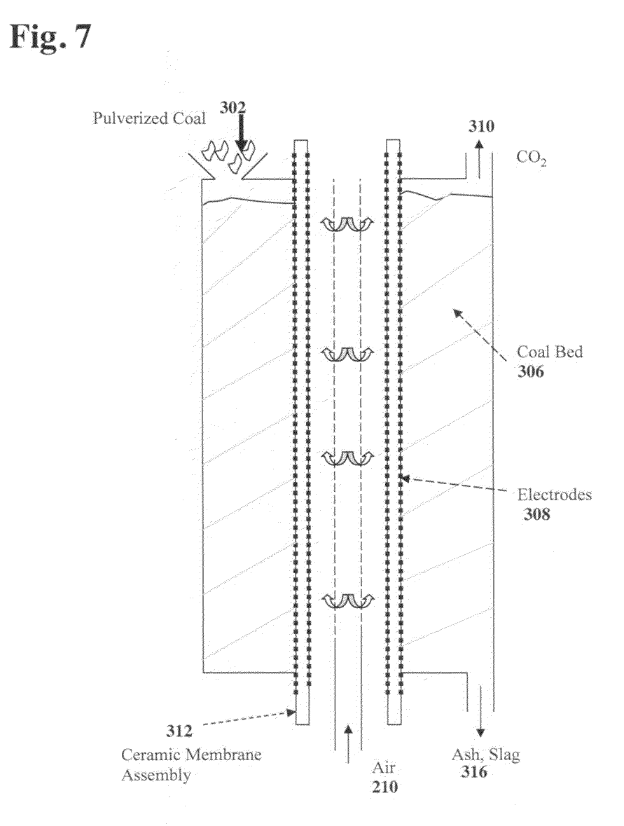

Other design concepts may include shell-and-tube type design where the pulverized coal bed 306 is outside the tube in touch with the anode 202 surface as shown in FIG. 7. This particular schematic does not show CO₂ 314 or captured coal recycling, but these features can easily be incorporated and falls within the scope of this invention.

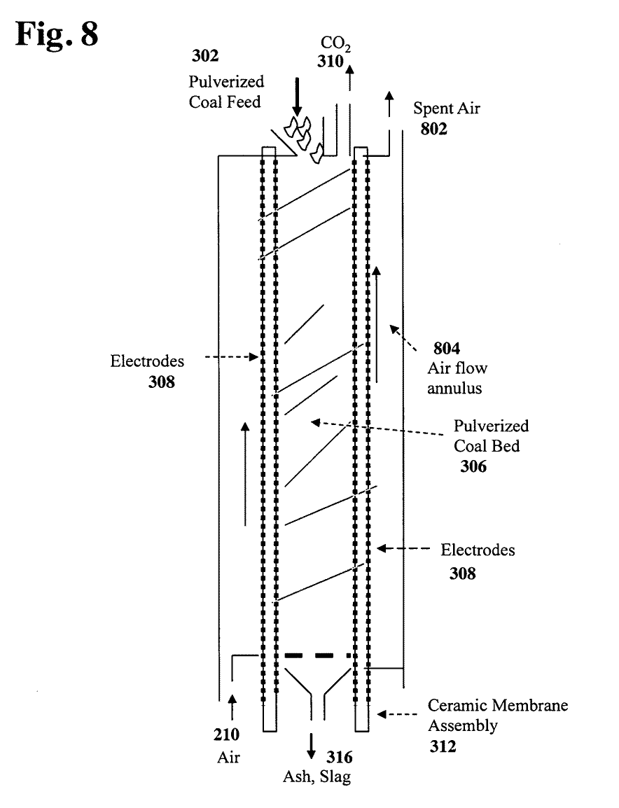

FIG. 8 shows spent air 802 and an airflow annulus 804.

Another variant of this is the inverted shell-and-tube type design (i.e., inverted version of FIG. 7) where the pulverized coal bed 306 is now inside the tube in touch with the anode 202 surface that is also inside the tube as shown in FIG. 8. The annulus between the metal shell and the cathode 206 surface facing the metal shell allows a flow of air 210. This particular schematic does not illustrate CO₂ 314 or captured coal recycling, but these features can easily be incorporated and falls within the scope of this invention.

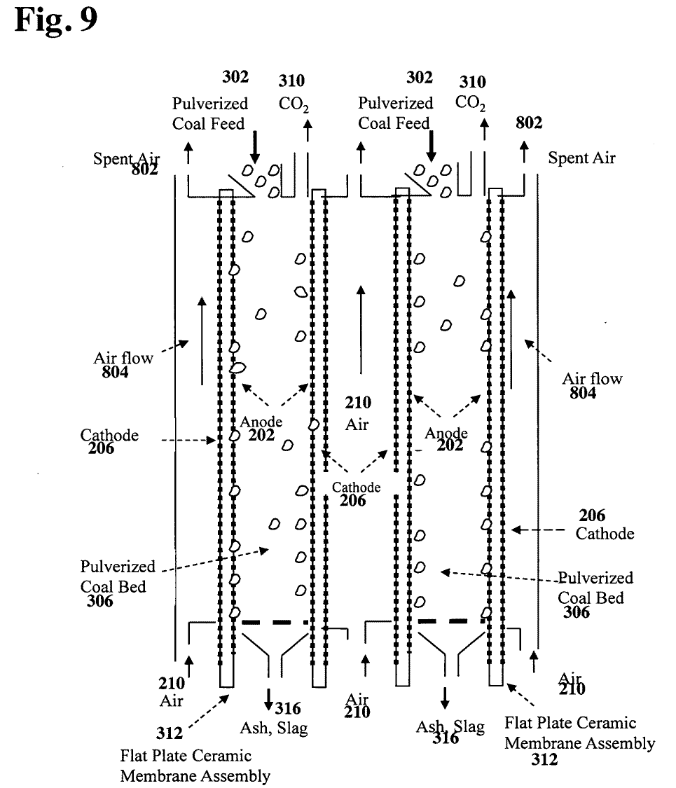

Although similar in operation, another design geometry involves the use of flat or corrugated planar ceramic membrane assemblies 312. These are multilayered structures that includes porous anode 202 (or cathode 206) support plates coated with thin impervious layers of the oxide conducting solid electrolyte 204 membrane, over which there is coated another thin but porous electrode layer to complete the fuel cell structure. The plates are stacked in parallel fashion in the reactor as shown in FIG. 9 such that the anode 202 surfaces face each other. Carbon-fuel 302 is fed in between the anode 202 surfaces in alternating pairs of plates while air 210 is flown along the outer surfaces that act as cathodes for the reduction of oxygen 208.

Yet another mode of operating the direct coal fuel cell is to couple it to CO₂ and SO₂ sequestration either inside the bed or outside the bed. Sequestration of CO₂ and SO₂ can be achieved inside the bed by introducing gettering agents such as calcium oxide, magnesium oxide, dolomite, a variety of micas, clays, and zeolites, or a variety of magnesium silicates (e.g., olivine, serpentine, talc) mixed with pulverized coal and fed directly into the bed. Mica, clay and zeolite individually refer to large families of minerals and materials. Examples of micas include muscovite, biotite, lepidolite and phlogopite; clays include montmorillonite, bentonite, hematite, illite, serpentine, and kaolinite; and zeolites include clinoptilolite, chabazite, phillipsite, mordenite, molecular sieves 13X, 5A, and ZSM-5. Of course, other members of the mica, clay and zeolite families are also applicable under this invention. All these inorganic compounds may be used to sequester carbon dioxide and oxides of sulfur. The gettering agents readily react with these oxidation products inside the bed forming solid carbonates and sulfates which eventually settle to the bottom of the bed due to their much denser bodies compared to coal, where they can be extracted. Or the flue gas leaving the bed can be treated with these gettering agents in a separate containment outside the bed where the reaction products CO₂ and SO₂ can easily be sequestered by fixing them as solid carbonates and sulfates. Some of the relevant reactions for mineral carbonization are provided below as examples.

Lime: CaO+CO₂=CaCO₃

Magnesia: MgO+CO₂=MgCO₃

Serpentine: Mg₃Si₂O₅(OH)₄₍ₛ₎+3CO_{2(g)}=3MgCO₃₍ₛ₎+2SiO₂₍ₛ₎+2H₂O

Olivine Mg₂SiO₄₍ₛ₎+2CO_{2(g)}=2MgCO₃₍ₛ₎+SiO₂₍ₛ₎

There are many embodiments of the present invention:
A fuel cell using a single temperature zone.
A fuel cell using direct physical contact (or touching) of anode surface with the coal particles.
A fuel cell using immersion or agitated bed to materialize contact.
A fuel cell using carbon directly, rather than intermediate conversion of coal to gaseous products.
A method of converting coal to electricity without the use of large quantities of water in contrast to the current technologies employed in coal-fired power plants
A fuel cell where there is a one step process for direct conversion of coal to electrical energy.
A process that does not combust coal, but oxidizes it.
A fuel cell that utilizes solid oxide electrolyte to supply the oxygen for the electrochemical oxidation of coal.
A fuel cell that produces highly concentrated (85-95% CO₂) flue gas that enables easy capturing and sequestration of the carbon dioxide.
A fuel cell that offers single source collection of CO₂.
A fuel cell that utilizes mineral carbonization.
A fuel cell that offers potentially near-zero emissions and stackless operation.

In another aspect, the invention is directed to a fuel cell for the direct conversion of a carbon-containing fuel into electricity. According to one embodiment of the invention, the fuel cell has an anode, which includes a carbon-containing fuel dispersed in a bath of an electronically-conducting, non-reactive and non-consumable molten metal. The molten metal does not form stable oxides under the conditions of operation. The fuel cell has a solid oxide electrolyte. In one embodiment, the solid oxide electrolyte is in the form of a one-end closed tube. Other geometries of the solid electrolyte are within the scope of this invention. In one embodiment of the one-end closed tube version, the one-end closed tube has an inside tube surface and an outside tube surface, such that a portion of the outside tube surface is dipped into the bath of the molten metal, and there is a cathode material coating a portion of the inside tube surface of the solid oxide electrolyte. In the fuel cell, electrical current is electrochemically generated by mass transport of oxygen across the solid oxide electrolyte for oxidation of the carbon-containing fuel in the anode after a phase having oxygen is brought into contact with a surface of the solid electrolyte. Air is an example of a phase having oxygen.

The electrochemical conversion of carbon into electricity is achieved in a high temperature fuel cell that features an oxide ion-selective solid electrolyte that supplies the oxygen required for the electrochemical oxidation of the carbonaceous fuel. Carbonaceous fuels in all natural and synthetic forms of carbon include coal (including anthracite, bituminous, subbituminous, and lignite coals), char, peat, coke, petroleum coke, tar sand, oil sand, charcoal, waste plastic, carbon produced by pyrolysis of carbonaceous substance, and biomass including animal and human waste, municipal waste, agricultural and forestry waste, is introduced into the anode compartment of the cell as solid fuel with or without a priori physical and chemical treatment (e.g., de-ashing, washing, cleaning, and desulfurization). Furthermore, the carbon fuel is introduced into the anode compartment of the cell with or without other solid constituents, such as sequestering agents for capturing the CO₂ and SO₂ produced.

The preferred embodiments for the molten metal bath are several:
The molten anode is desirably a good electronic conductor and possesses a suitable melting temperature that is appropriate for the preferred operating temperature of the fuel cell, which is from 250° C. to 1300° C.
It is desirable to choose the metal from those that are stable in the presence of oxygen at the anode and not form a stable oxide at the fuel cell operating temperature. A good example of this type of metal is silver, which does not have a stable oxide above 230° C. So in the elevated operating temperatures of the DCFC cell it will retain its metallic character and will not form an oxide.
The solubility of oxygen in this molten metal anode should be sufficiently high to allow high throughput. The high solubility of oxygen in the molten bath facilitates larger concentrations of oxygen available for the oxidation reaction with the carbon.
The diffusion coefficient of oxygen in the molten metal anode should also be sufficiently high for the fuel cell to operate at high current densities. This of course translates into high power densities for the fuel cell.
The molten metal anode should be stable with respect to carbon, hydrogen, and nitrogen, and does not form stable carbides, hydrides, and nitrides.

The DCFC according to the current invention requires that one surface of the solid oxide electrolyte (such as YSZ) is in contact with molten metal bath that contains the carbon fuel and also serves as the anode, while the other surface which serves as the cathode is in contact with an oxygen source, such as ambient air, or pure oxygen to furnish the oxygen needed for the oxidation reaction at the anode. The solid oxide electrolyte serves as a selective membrane for transporting oxygen ions from the air-side cathode to the molten bath anode where it reacts with the carbon particles to produce electricity.

Many geometries, structures, and arrangements of the solid oxide electrolyte within the fuel cell are within the scope of this invention. In one embodiment, the solid oxide electrolyte is as a thin layer coated onto a porous cathode or a porous anode support, which optionally provides mechanical support for the thin layer of solid oxide electrolyte. Preferably, the layer of solid oxide electrolyte has a thickness of 1 to 100 microns. The geometry of this configuration could be in the form of a tube, a flat plate, or a corrugated plate. In the figures, examples are presented of embodiments employing tubes. However, these examples are non-limiting. Geometries other than tubes may be employed. Further, within the tube geometry, the tube shape may be primarily of solid electrolyte or it may be of a coating of solid electrolyte on another substrate.

One surface of the YSZ tube is coated with a suitable cathode material, where as discussed above, using Kroger-Vink defect notation, the electrochemical reduction of oxygen takes place as follows:

O_{2(g)}+2Vₒ″_{(YSZ)}+4e′_{(electrode)}=2Oₒ^{x}_{(YSZ)} (2)

While the oxygen vacancies, Vₒ″_{(YSZ)}, migrate under the influence of the concentration gradient through the YSZ solid electrolyte from the anode to the cathode, oxygen ions are transported in the reverse direction from the cathode to the anode where they participate in the electrochemical oxidation of carbon.

C_{(Ag)}+2Oₒ^{x}_{(YSZ)}=CO_{2(g)}2Vₒ″_{(YSZ)}+4e′_{(electrode)} (3)

The electrons that are released during the oxidation reaction at the molten anode travel through the external circuit towards the cathode, producing useful electricity. The oxygen chemical potential difference between the anode and the cathode (i.e., air) provides nearly 1-volt open circuit voltage at about 1000° C.

According to one embodiment, YSZ is the preferred the solid electrolyte. However, scandia stabilized zirconia has a higher conductivity than its yttria counterpart. Also, it is possible to employ tetragonal zirconia, which is known to possess higher conductivity and better thermal shock resistance than cubic zirconia electrolytes.

In another aspect of the invention, the solid oxide electrolyte can be an oxide that includes Hf, Zr, Y, Sc, Yb, La, Ga, Gd, Bi, Ce, Th, where the oxides are doped with oxides such as zirconium oxide doped with yttrium oxide, alkaline earth metals and rare earth metals.

Other solid electrolytes that exhibit selective oxygen conduction are also suitable for the disclosed DCFC system. These include solid solutions of alkali or rare earth oxides with thoria (i.e., ThO₂), hafnia (i.e., HfO₂), and ceria (e.g., CeO₂—Gd₂O₃) of the fluorite structure, the pyrochlore structure oxides as well as ionically conducting perovskites such as doped gallates (e.g., LaGaO₃), and hexagonal structure apatites, giving a wide ranging choice of structures.

The concept of molten metal bath (or an electronically conductive metal oxide molten bath) is ideally suited not only to make good electrical contact with the YSZ tube, but also to contain and disperse both the carbon source (coal, char, peat, coke, biomass, etc) and the CO₂ and SO₂ gettering solid phase.

The preferred choice for the molten metal bath is silver for several important reasons. Its melting point of 960° C. is ideally suited for the efficient operating regime of solid oxide fuel cells (SOFC). Silver also is the metal with one of the highest dissolved oxygen concentrations at any temperature. Furthermore, the diffusion coefficient of oxygen in Ag is the highest in any metal, and is measured to be 1.5×10⁻⁵ cm²/s at 700° C. Silver is also an excellent electronic conductor with good wetting capability for the YSZ surface.

Equally important is the fact that Ag does not form stable oxides at the elevated temperatures employed for solid oxide fuel cells, where it is non-reactive and non-consumable. The only stable oxide of silver, Ag₂O is unstable above 230° C. Hence, the problem of oxide formation at the anode is eliminated when Ag is used for the molten anode. This is a critically important advantage in order to maintain a stable and coherent interface between the ionically conducting solid electrolyte and the molten Ag anode. Otherwise, any reaction product forming at this interface has the potential of impeding or blocking the charge transfer reaction at the anode, ultimately increasing anodic polarization and degrading the fuel cell efficiency. In short, the use of Ag as the molten anode eliminates the possibility of these deleterious effects.

Another virtue of Ag that is of interest to this invention is that it does not react with carbon, and does not form a carbide phase. So the carbon fuel can safely and easily be distributed and dispersed into the molten Ag bath without degradation or loss to undesirable chemical reactions.

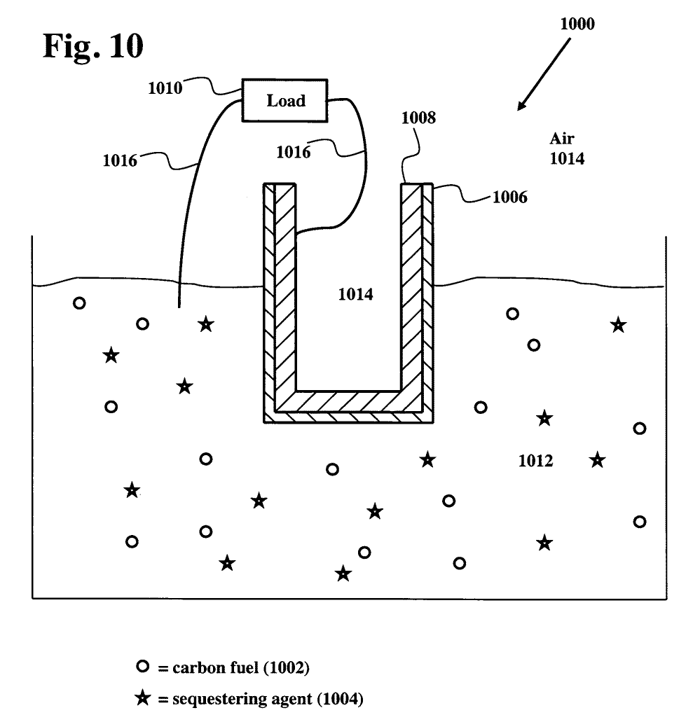

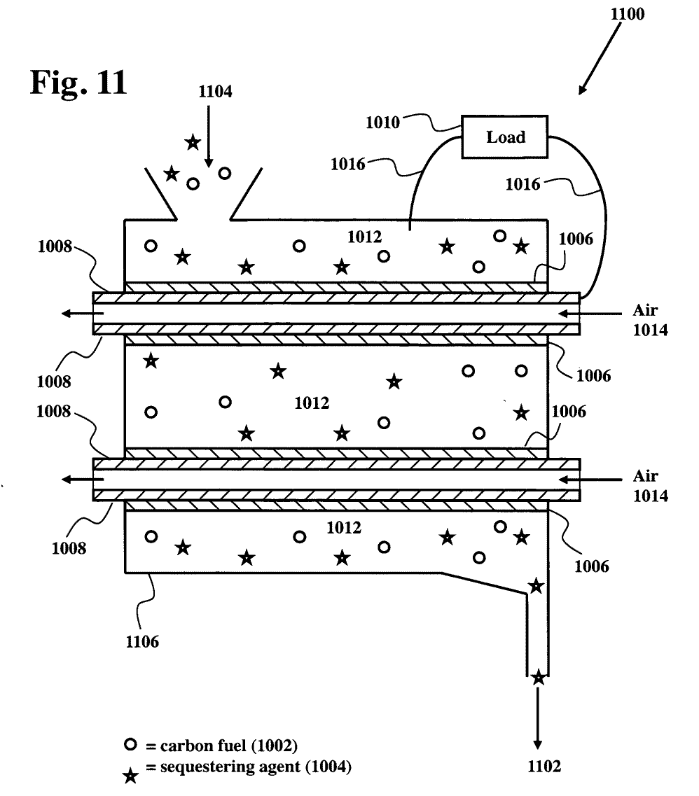

One embodiment of the DCFC employs one-end closed solid oxide electrolyte tubes that are dipped into the molten anode bath such that the closed end of the tubes are in direct contact with the molten bath which contain a dispersion of carbon fuel particles as well as a suitable sequestering agent for CO₂/SO₂ capture. FIG. 10 shows the schematic design of this system. In another embodiment, open-ended solid oxide electrolyte tubes are stacked in a shell-and-tube geometry and supported by the end plates of the shell as shown in FIG. 11. For brevity, electrical lead connections to only one cell are illustrated. The external surfaces of the tubes are in direct contact with the molten anode bath containing a proper dispersion of the carbon source and the CO₂/SO₂ gettering agent.

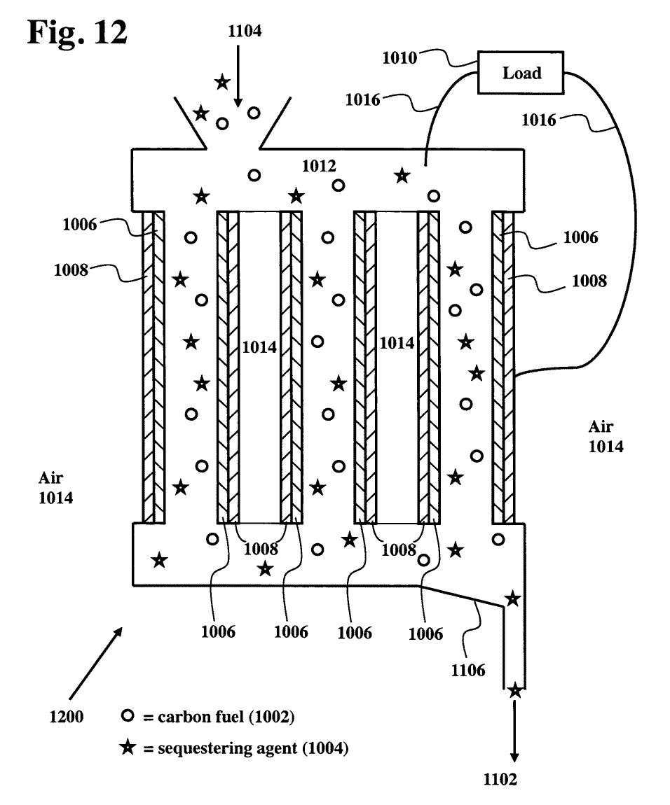

In another embodiment, the molten anode containing the carbon particles and the CO₂/SO₂ gettering agent reside inside the open-ended solid oxide electrolyte tubes. In this configuration, shown in FIG. 12, the anode is located inside the tubes, while the cathode is located at the external surface of the tubes.

Each of these individual DCFC configurations generate valuable waste heat at high temperatures that may be used for process heating or steam generation to drive a turbine and considerably increase the system efficiency of the overall process. This combined gas cycle operation has the added advantage of using the waste heat from the turbine for heating up the makeup air for the cathode.

FIG. 10 shows an example of a cross-sectional view of a molten anode fuel cell 1000. The fuel cell 1000 includes a cathode 1008, a solid oxide electrolyte 1006, a molten anode 1012, a load 1010 to be driven by the fuel cell 1000, and electrodes 1016 that connect the cathode 1008, anode 1012, and load 1010 together. Also shown is air 1014. The molten anode includes a carbon fuel 1002 and, optionally, a sequestering agent 1004. The example in FIG. 10 shows a kind of open tube or open box half dipped in a tank of molten anode 1012. Actual implementation may be easier with more containment.

FIG. 11 shows an example of a cross-sectional view of a molten anode fuel cell 1100 with air 1014 flowing through tubes. The fuel cell 1100 includes a cathode 1008, a solid oxide electrolyte 1006, a molten anode 1012, input fuel 1104 (including carbon fuel 1002 and optional sequestering agent 204), molten anode containment 306, and a spent sequestering agent output 1102. Also shown is air 1014 moving through tubes of electrolyte 1006. The molten anode includes a carbon fuel 202 and, optionally, a sequestering agent 204. Also shown are a cathode 1008 (which is in between the electrolyte 1006 and air 1014), a load 1010 to be driven by the fuel cell 1100, and electrodes 1016 that connect the cathode 1008, anode 1012, and load 1010 together. For clarity, electrical lead connections to only one cell are illustrated. In this example air 1014 flows through the tubes to provide the oxygen to the fuel cell 1100. Of course, it is also possible to have the molten anode 1012 flow through the tubes as well.

FIG. 12 shows an example of a molten anode fuel cell 1200 with a molten anode 1012 in tubes. For brevity, electrical lead connections to only one cell are illustrated. The fuel cell 1200 includes a cathode 1008, a solid oxide electrolyte 1006, a molten anode 1012, input fuel 1104 (having carbon fuel 1002 and optional sequestering agent 1004, molten anode containment 1106, and a spent sequestering agent output 1102. Also shown is the molten anode 1012 in tubes of electrolyte 1006, the tubes being surrounded by air 1014. The molten anode includes a carbon fuel 1002 and, optionally, a sequestering agent 1004. Also shown are a cathode 1008 (which is in between the electrolyte 1006 and air 1014), a load 1010 to be driven by the fuel cell 1200, and electrodes 1016 that connect the cathode 1008, anode 1012, and load 1010 together. For clarity, electrical lead connections to only one cell are illustrated. In this example air 1014 flows around the outside of the tubes to provide the oxygen to the fuel cell 1200.

The present invention offers the following advantages.
Offers a theoretical conversion efficiency of 100%
Offers reduced emissions per unit of electricity generated
Offers reduced consumption of carbon fuel per unit of electricity generated
Uses coal and other carbonaceous fuels directly, rather than intermediate conversion to gaseous products such as CO and H₂
Offers one step process for direct conversion of coal and other carbonaceous fuels to electrical energy
Eliminates Carnot cycle limitations related to converting chemical energy into electricity
Does not combust coal or carbon, but oxidizes it
Converts coal and other carbonaceous fuels to electricity without the use of large quantities of water in contrast to the current technologies employed in coal-fired power plants
Utilizes a solid oxide electrolyte to supply the oxygen for the electrochemical oxidation of coal
Offers practical high conversion efficiency
Does not require a priori chemical treatment of coal for removal of ash or desulfurization
Eliminates need for a priori gasification of coal and other carbonaceous fuels in order to be able to use it in a fuel cell
Insensitive to the source of carbon and quality of coal
Uses sulfur tolerant anode material
Produces highly concentrated (85-95% CO₂) flue gas that enables easy capturing and sequestration of the carbon dioxide.
Single source collection of CO₂
Provides environmentally friendly solution to utilization of coal and other carbonaceous fuels for energy generation
Offers potentially near-zero emissions

Embodiments of the molten anode of the present invention are derived from the following characteristics:
The molten anode should be an electronic conductor.
The molten anode should have a melting point that lies within 250° C.-1300° C.
Preferably, the molten anode should not form a stable oxide within this temperature regime.
If the molten anode does form a stable oxide layer that block oxide ions, the oxide should not be thermodynamically stable at the operating temperature of the fuel cell.
The molten anode should not form a stable carbide within this temperature regime.
The molten anode should exhibit high solubility for oxygen within this temperature regime.
The molten anode should exhibit high diffusion coefficient for oxygen transport within this temperature regime.

What is claimed is:

1. A fuel cell comprising:
an anode, wherein said anode is a chemically non-reactive and non-consumable anode that is chemically stable in composition and structure, wherein said anode is catalytically active;
a cathode, wherein one surface of said cathode is in contact with air, wherein said air supplies oxygen to said cathode;
a solid oxide electrolyte that selectively transports oxide ions from said cathode to said anode for an oxidation reaction, wherein said solid oxide electrolyte is disposed between said anode and said solid cathode; and
a single temperature zone,
wherein said anode is in direct physical contact with a carbon-containing fuel and electrical current is generated by said oxidation of said carbon-containing fuel by said oxygen.

2. The fuel cell of claim 1, wherein said anode comprises an electronically-conducting molten anode.

3. The fuel cell of claim 2, wherein said electronically-conducting molten anode comprises silver.

4. The fuel cell of claim 1, wherein said carbon containing fuel further comprises a sequestering agent, wherein said sequestering agent is suitable for CO₂/SO₂ capture.

5. The fuel cell of claim 1, wherein said solid oxide electrolyte comprises a solid oxide electrolyte tube, wherein said solid oxide electrolyte tube is disposed between said anode and said cathode.

6. The fuel cell of claim 5, wherein said cathode comprises a cathode tube, wherein said oxygen containing air flows there through.

7. The fuel cell of claim 5, wherein said anode comprises a molten anode, wherein said molten anode is disposed in said solid oxide electrolyte tube, wherein said solid oxide electrolyte tube is surrounded by said oxygen containing air.

8. The fuel cell of claim 1, wherein said anode comprises a molten anode, wherein said molten anode comprises a molten metal bath, wherein said metal does not form a stable oxide under conditions of operation.

9. The fuel cell of claim 1, wherein said oxidation of said carbon-containing fuel is by oxygen provided through said solid oxide electrolyte to said anode.

10. The fuel cell of claim 1, where said carbon-containing fuel comprises a carbon rich substance.

11. The fuel cell of claim 1, wherein said fuel cell is a generally shell-and-tube configuration, wherein a bed of said carbon-containing fuel and said anode is outside of said tube.

12. The fuel cell of claim 1 wherein said fuel cell is a generally shell-and-tube configuration, wherein a bed of said carbon-containing fuel and said anode is inside of said tube.

13. The fuel cell of claim 1, wherein said fuel cell has an operating temperature in the range 250 to 1300 degrees Centigrade.

14. The fuel cell of claim 1, where said carbon-containing fuel is selected from a group consisting of coal, charcoal, peat, coke, char, petroleum coke, oil sand, tar sand, waste plastics, biomass, agriculture waste, forest waste, municipal waste, human waste, biological waste, and carbon produced by pyrolysis of a carbonaceous substance of solid, liquid or gaseous form.

15. The fuel cell of claim 1, wherein said solid oxide electrolyte comprises a solid oxide electrolyte layer coated onto a said cathode, wherein said cathode is porous, wherein said solid oxide electrolyte layer has a thickness in a range of 1 to 100 microns.

16. The fuel cell of claim 1, wherein said solid oxide electrolyte is selected from an oxide group consisting of Hf, Zr, Y, Sc, Yb, La, Ga, Gd, Bi, Ce, Th, wherein said oxides are doped with oxides selected from a group consisting of zirconium oxide doped with yttrium oxide, alkaline earth metals and rare earth metals.
